(19) United States
(12) Patent Application Publication
(10) Pub. No.: US 2010/0225484 A1
(43) Pub. Date: Sep. 9, 2010

(54) OBJECT LOCALIZATION METHOD, SYSTEM, TAG, AND USER INTERFACE DEVICE

(75) Inventors: Bartel M. Van De Sluis, Eindhoven (NL); Lorenzo Feri, Eindhoven (NL); Tim C.W. Schenk, Eindhoven (NL); Sel B. Colak, Eindhoven (NL); Paulus H.A. Damink, Eindhoven (NL); Hendricus T.G.M. Penning De Vries, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/663,523

(22) PCT Filed: Jun. 6, 2008
(86) PCT No.: PCT/IB08/52231

§ 371 Date: May 20, 2010

(30) Foreign Application Priority Data
Jun. 14, 2007 (EP) 07110254.5
Nov. 7, 2007 (EP) 07120141.2

(51) Int. Cl. G08B 13/14

(52) U.S. Cl. 340/572.4

(57) ABSTRACT

Proposed is an object localization method, system and user interface device for locating a (misplaced) object (10) in an area of a construction (1). The method comprises the steps of (i) identifying the object (10), (ii) providing an illumination device (20) comprising a plurality of light sources (30) modulated to emit light comprising light source identification codes (35), (iii) illuminating the tag (11) with light emitted by the light sources (30), (iv) requesting the tag (11) to measure the illumination and to identify the light sources (30) illuminating the tag by their light source identification codes (35), (v) transmitting object location data from the tag (11) relating to the measured illumination and light source identification codes (35) to a master controller (25) arranged to control the illumination device (20), (vi) providing a feedback signal related to the object (10) using the master controller (25). The method is characterized by using a lighting infrastructure (27) of the construction (1) in providing the illumination device (20). Advantageously, the method enables a user to obtain a feedback signal about the location of the desired object without the need to move through the construction. Instead, the method enables the user to locate many objects within a construction or area from a single fixed position.

### FIELD OF THE INVENTION

The invention relates to a method for locating an object in a construction according to the preamble of claim 1. Furthermore, the invention relates to a system for locating an object in a construction according to the preamble of claim 9. The invention also relates to an object localization user interface device according to the preamble of claim 13. Finally, the invention relates to a light sensitive tag according to the preamble of claim 16. Such a method, system and user interface device in particular can be used in environments, such as libraries, warehouses, and shops, where the object to be located is interdispersed between many similar objects. Furthermore, the light sensitive tag may be used to automatically illuminate a located object.

### BACKGROUND OF THE INVENTION

An embodiment of a method of the kind set forth is known from U.S. Pat. No. 7,154,395. This document discloses a wireless location and identification method and system. The method uses and system comprises a controller/projector as a user interface device for locating an object. The controller/projector projects in a well defined and confined area both a wireless RF output signal and a visible output image. The illuminated pixels forming the image comprise a unique temporal sequence of light intensities. In response to the wireless RF output signal a light sensitive tag on the object senses the unique temporal light intensity sequence of the particular pixel illuminating the tag. Identifying the particular pixel by its temporal sequence enables the tag to locate it self within and relative to the illuminated (image) area. Subsequently, the tag transmits location data to the controller/projector. Additional to the location data, the tag may transmit object data (f.i. relating to content of the object such as the terminal sell-by date of perishable items) stored in the tag, enabling the controller/projector to project the object data directly in the image area to augment the location feedback to a user.

The advantage of this approach lies in the fact that it provides a versatile framework for selecting tags, identifying tags, collecting tag data, displaying information related to the tags, and interacting with the data. This makes the approach useful for f.i. warehouse management. The solution described in U.S. Pat. No. 7,154,395, however, has as a drawback that the projected image area limits the effective field of illumination and thus the effective field available for locating the object. Hence, a warehouse operator desiring to locate a misplaced object, for instance knowing its presence from a computer database, will have to scan the complete warehouse area (and scaffolds) due to the limited field of view of the image area.

### SUMMARY OF THE INVENTION

It is an object of the present invention to provide a method for locating an object in a construction of the kind set forth, which has an unlimited field of view relative to the size of the construction. This object is achieved with the object localization method according to the invention as defined in claim 1. According to a first aspect, the invention is characterized by using a lighting infrastructure of the construction in providing the illumination device.

Advantageously, the lighting infrastructure of the construction includes luminaires of all kinds, comprising incandescent bulbs, halogen bulbs, fluorescent lamps, HID bulbs, and (in)-organic LEDs and extends throughout (and adjacent to) the construction. Advantageously, the method enables a user to obtain a feedback signal about the location of the desired object without the need to move through the construction. Instead, the method enables the user to locate many objects within a construction or area from a single fixed position.

The term “construction” means any enclosure, including (but not limited to) moveable enclosures such as vehicles. Furthermore, the term not only includes man-made constructions such as buildings or cars, but includes also natural constructions such as caves. Moreover, the term “area” means any subset of an enclosed space in the construction or a defined space around the construction, i.e. in free air such as a parking lot in front of a factory. Hence, the term “area” includes (but not limited to) for example a lobby, a corridor, a small room, a meeting room, and an office cubicle. An “area” may also refer to a define space adjacent to a vehicle and the streets of a city.

U.S. Pat. No. 6,865,347 comprises further prior art and discloses a method for determining the absolute three-dimensional position of an object in a construction, which comprises the use of a three-dimensional optical detector to determine the relative position of the detector to at least one of the light sources of the lighting infrastructure of a construction. Furthermore, the light sources transmit—through modulation of light emitted—their absolute position relative to a fixed position (the origin of a predetermined coordinate system) in the construction, enabling the detector to calculate its absolute coordinates.

In an embodiment of the present invention, providing the feedback signal comprises controlling the light emitted by the lighting infrastructure on the basis of the transmitted object location data to create a visual feedback signal related to the location of the object. Advantageously, the object interdispersed among many similar objects visually stands out, enabling a user to recognize the desired object from a distance.

According to an embodiment the invention further comprises the step of choosing the visual feedback signal from the group consisting of a dynamic illumination variation and a static illumination alteration. Advantageously, the dynamic illumination variation or static illumination alteration comprises an intensity or color change of the light emitted by the light sources of the lighting infrastructure. Changing light color, intensity and temporal dynamics enhances the visibility of the desired object relative to other objects.

An embodiment further comprises the steps of arranging the lighting infrastructure in at least a first group and a second group of light sources and creating the visual feedback signal by controlling the light emitted by the first group. Advantageously, only a part of the light sources in the lighting infrastructure of the construction need to be controlled to make the object stand out. Advantageously, an embodiment further comprises the step of controlling the light emitted by the second group to enhance the contrast between the visual feedback signal and its surrounding.

According to the invention an embodiment further comprises the step of making use of an object localization user interface device for the steps of identifying the object and requesting the tag to measure the illumination and to identify the light sources by their light source identification codes. Advantageously, the embodiment enables the user to locate many objects within a construction or area from a single fixed position.

An embodiment further comprises the step of locating the object localization user interface device relative to the light sources on the basis of measured illumination and light source identification codes, transmitting device location data from the object localization user interface device relating to the measured illumination and light source identification codes to the master controller, and controlling the intensity of the light emitted by the lighting infrastructure to create a visual guiding path from the location of the object localization user interface device to the location of the object. Advantageously, the embodiment provides a guide to the user from his position to the position of the desired object. Implementation of this embodiment becomes especially attractive when obstacles block the user to directly observe the object. As an example, the user finds him self in a first area while a second area contains the object. Alternatively, the area containing the object constitutes a library or warehouse hall provided with many scaffolds forming corridors and the user finds him self in a first corridor while a second corridor contains the object.

According to another aspect, the invention provides an object localization system according to the preamble of claim 9, characterized in that the illumination device is comprised in a lighting infrastructure of the construction. In an embodiment of the invention the illumination device is arranged to create a visual feedback signal on or around the object by controlling the light emitted by the light sources on the basis of the received (object) location data. Advantageously, the object interdispersed among many similar objects visually stands out, enabling a user to recognize the desired object from a distance.

In an embodiment the lighting infrastructure is arranged to comprise at least a first group and a second group of light sources. Advantageously, only a part of the light sources in the lighting infrastructure of the construction need to be controlled to make the object stand out.

An embodiment of the invention further comprises an object localization user interface device for identifying the object to be located.

According to yet another aspect the invention provides an object localization user interface device according to the preamble of claim 13 characterized in that the device comprises communication means arranged to request the tag, in responds to a user input signal, to measure the illumination of the tag and to identify the light sources illuminating the tag by their light source identification codes. In an embodiment the object localization user interface device further comprises a photodetector arranged to measure the illumination of the photodetector and to identify the light sources illuminating the photodetector by their light source identification codes. Advantageously, the embodiment enables the object localization user interface device to determine its own position within the construction. In yet another embodiment, the communication means are further arranged to transmit device location data from the object localization user interface device relating to the measured illumination and light source identification codes to the master controller. Advantageously the embodiment enables the master controller to determine the distance between the user interface device an the desired object in order to control the lighting infrastructure to provide a well lit guiding path from the position of the user interface device to the object.

According to a forth aspect the invention provides a light sensitive tag according to the preamble of claim 16 characterized in that the tag is further arranged, in responds to a user defined request, to communicate to the master controller to control the plurality of light sources of the lighting infrastructure to provide a visible feedback signal on or in the vicinity of the tag in dependence on the tag's location relative to the lighting infrastructure. Advantageously, a user may apply the tag to provide a visible feedback signal on or in the vicinity of the tag independent of its location. Consequently, even when the tag moves relative to the lighting infrastructure, the lighting infrastructure will be controlled to continuously provide the visible feedback signal on or in the vicinity of the tag.

These and other aspects of the invention will be apparent from and elucidated with reference to the embodiments described hereinafter.

### BRIEF DESCRIPTION OF THE DRAWINGS

Further details, features and advantages of the invention are disclosed in the following description of exemplary and preferred embodiments in connection with the drawings.

FIG. 1 shows a prior art localization system

FIG. 2 shows a first embodiment of the invention

FIG. 3 shows a second embodiment of the invention

FIG. 4 shows an application of the invention

### DETAILED DESCRIPTION OF THE EMBODIMENTS

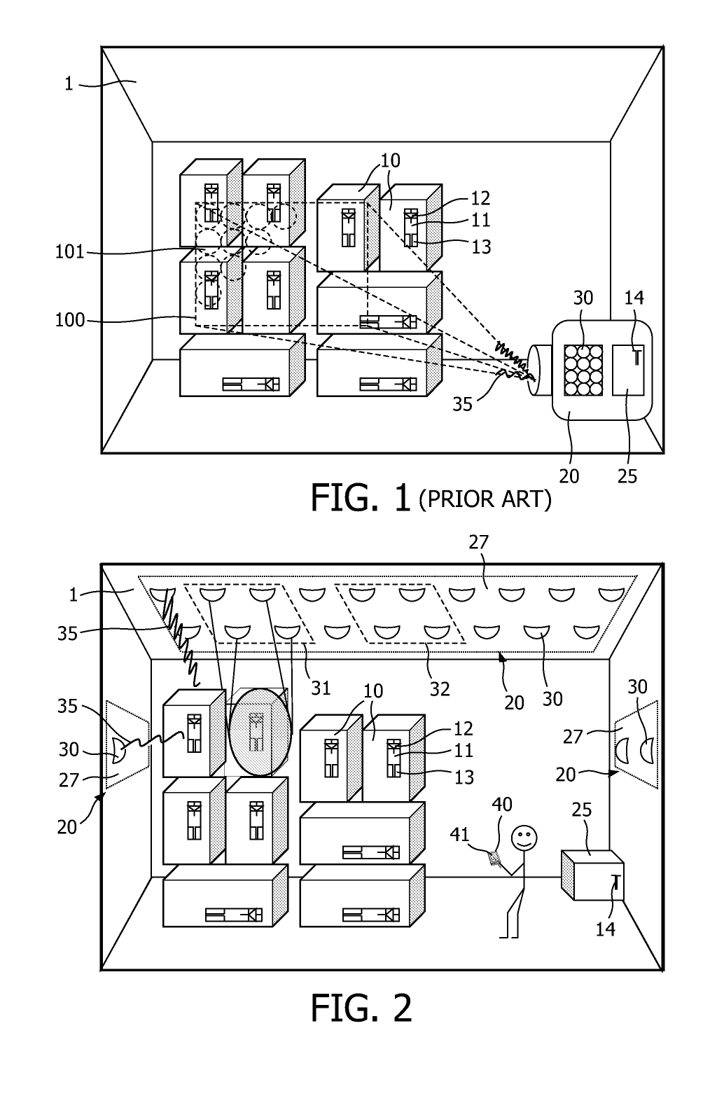

FIG. 1 shows a prior art localization system, comprising a projector (i.e. illumination device 20) as a user interface device for locating an object 10 in a construction 1 (f.i. a number of stacked boxes in a warehouse). The projector comprises (i) a pixilated lamp (i.e. a plurality of light sources 30), (ii) a master controller 25 for controlling a.o. the lamp, and (iii) a transceiver 14 for transmitting and receiving RF signals. It projects in a well defined and confined area both a wireless RF output signal and a visible output image field 100. The illuminated pixels 101 forming the image field 100 comprise a unique temporal sequence of light intensities (the light source identification codes 35). In response to the wireless RF output signal a light sensitive tag 11—comprising (i) a photodetector 12, (ii) a transceiver 13, and (iii) a microcontroller with memory (not shown)—on the object 10 senses the unique temporal light intensity sequence of the particular pixel 101 illuminating the tag 11. Identifying the particular pixel 101 by its temporal sequence enables the tag 11 to locate it self within and relative to the illuminated area (image field 100). Subsequently, the tag 11 transmits location data to the projector. Additional to the location data, the tag 11 may transmit object data (f.i. relating to content of the object such as the terminal sell-by date of perishable items) stored in the tag, enabling the projector to project the object data directly in the image field 100 to augment the location feedback to a user.

Hence, a warehouse operator desiring to locate a (misplaced) object 10 needs to walk through his construction 1 and scan all the stacks with his projector in order to locate it. The prior art method and system do not allow locating objects 10 outside the image field 100 of the projector. This constitutes a considerable problem and causes a substantial economical loss to the warehouse operator due to the necessity of material resource and time allocation inherent to the prior art method.

The invention provides a solution for this problem by providing an object localization method for locating an object 10 (comprising a light sensitive tag 11) in an area of a construction 1 and using the lighting infrastructure 27 of the construction 1 in providing the illumination device 20 (see FIG. 2). Advantageously, the method provides a feedback about the location of the desired object 10 without the need to scour the complete construction 1.

According to the method provided by the invention the warehouse operator identifies the object 10. In an embodiment this identification occurs using an object localization user interface device 40. Subsequently, transmitting a wireless (RF) signal, including a tag-ID, will request the tag 11 to measure the illumination provided by the light sources 30 of the illumination infrastructure 27 of the construction 1. For this purpose the object 10 incorporates the light sensitive tag 11 comprises a photodetector 12 and a transceiver 13, and a microcontroller with memory (not shown).

Active battery powered RFID tags can suitably be used. Advantageous, however, is the use of passive unpowered RF tags since they do not require the relative expensive battery pack. A photodetector is one of the few types of sensors compatible with the size and power requirements of passive RFID tags. Advantageously, the RF signal requesting the passive RFID tags to measure the illumination will power-up and activate them. As there is no need, up to that point they are not photosensing.

According to the invention, the lighting infrastructure 27 provides the light illuminating the tag 11. In order to make the localization of the object 10 possible, the light sources 30 constituting the lighting infrastructure 27 modulate the light emitted at frequencies beyond visual perception by the human eye to comprise light source identification codes 35. Hence, the light modulation leads to an intelligent lighting infrastructure 27 comprising capabilities besides and beyond the traditional illumination application. Incorporating a spread spectrum modulator in the light sources 30 efficiently realizes this modulation. Advantageously, CDMA, i.e. Code Division Multiple Access, coding provides well differentiated light source identification codes 35. The CDMA coding scheme may be based on On-Off Keying. On-Off Key (OOK) modulation represents digital data as the presence or absence of a carrier wave. In its simplest form the presence of a carrier for a specific duration represents a binary ‘one’ and its absence for the same duration represents a binary ‘zero’, although in principle any digital encoding scheme may be used. Alternatively, the modulation method may be a generalization of BiPhase (BP) modulation.

Determining the light source identification codes 35 allows the tag 11 to calculate the contribution to the illumination from the individual light sources 30. Based on the identified light sources, the tag 11 creates object location data comprising information relating to the location of the object.

The method advantageously does not need to determine an absolute or relative location (as the prior art methods and systems need to do) with respect to a reference coordinate system. The method of the invention simply provides the master controller 25 of the lighting infrastructure 27 with object location data relating to the tag-ID and the light sources 35 identified by the desired tag 11. Nor does the master controller 25 need to calculate an absolute or relative location of the object 10 with respect to a reference coordinate system. Using received data the master controller 25 simply adjusts the lighting setting of the infrastructure 27 to provide a visual feedback signal relating to the location of the object 10 to the operator.

In an embodiment of the invention the visual feedback signal is simply a static illumination alteration, such as a spot of light on or around the object 10 located. The spot having a larger illumination level then its surroundings. Advantageously, this enables the operator to recognize it from a distance, even for objects interdispersed among many similar objects. Alternatively, the visual feedback signal may constitute a dynamic illumination variation, such as time-depend blinking of the light on or around the object 10. Advantageously, the dynamic variation or static alteration comprises an intensity or color change of the illumination. Changing the light color, its intensity and/or its temporal dynamics enhances the visibility of the located object relative to other objects.

In an embodiment of the invention the method arranges the light sources 30 in a first group 31 and a second group 32 and creates the visual feedback signal for the operator by controlling/adjusting the light emitted by the light sources from the first group only. Advantageously only a part of the light sources 30 in the lighting infrastructure 27 of the construction 1 need to be controlled to make the object stand out. Advantageously, this leaves the illumination in for instance areas of the construction 1 not containing the desired object 10 unaltered. In an embodiment, the method controls/adjusts the light emitted by the light sources 30 from the second group 32 to enhance the contrast between the visual feedback signal and its surroundings. For instance, the second group 32 comprises the light sources 30 adjacent to the light sources in the first group 31. Having the master controller 25 dim or reduce the light emitted by the second group's light sources realizes the enhancement. Alternatively, the color of the light emitted by the second group 32 contrasts the color of the light emitted by the first group 31.

In an embodiment the invention makes use of an object localization user interface device 40 for identifying the object 10 to be located and requesting the tag 11 incorporated by the object to measure the illumination and identify the light sources 30 by their light source identification codes 35. The object localization user interface device 40 may be a hand held device, such as a PDA. Alternatively, it may be at a fixed location, such as on the wall confining an area of the construction 1 or in a control room. Advantageously, to communicate the identification request the object localization user interface device 40 comprises communication means 41, such as a transceiver.

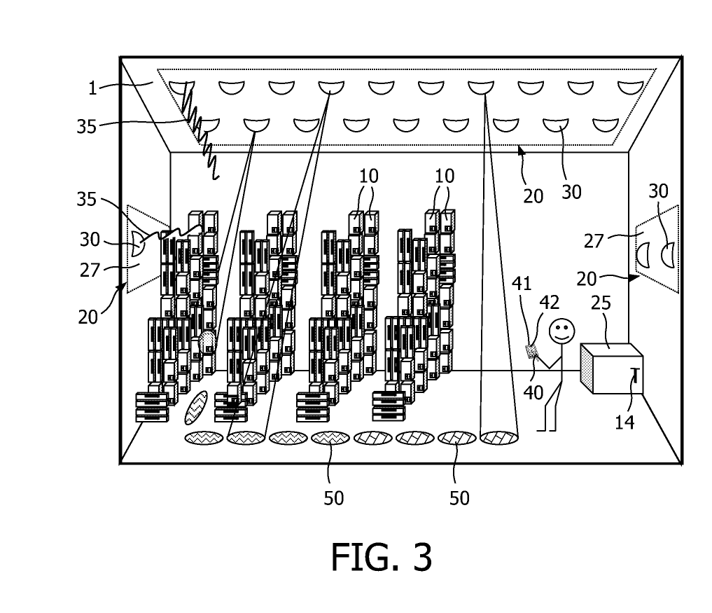

In an embodiment shown in FIG. 3 the object localization user interface device 40 advantageously incorporates a photodetector 42. This allows the object localization user interface device 40 to pinpoint its own location relative to the light sources 30 on the basis of measured illumination at the photodetector 42. Note that arranging the communication means 41 and photodetector 42 as incorporated in a light sensitive tag 11 forms a viable option. Subsequent transmission of device location data relating to the measured illumination and light source identification codes 35 to the master controller 25 allows for controlling the intensity of the light emitted by the lighting infrastructure 27 to create a visual guiding path 50 from the location of the object localization user interface device 40 to the location of the (desired) object 10. As with the visual feedback signal on or around the object 10, the visual guiding path 50 may be created using a dynamic illumination variation or a static illumination alteration. Again, the variation and alteration may comprise an intensity or color change. Advantageously, the embodiment provides a guide to the user from his position in a first area to the position of the desired object contained in a second area. Alternatively, the area containing the object constitutes a library or warehouse hall provided with many scaffolds forming corridors and the user finds him self in a first corridor while a second corridor contains the object.

Note that the method allows two operators to use it at the same time. In an embodiment the device location data transmitted to the master controller 25 comprises additionally an object location user interface device ID. This ID information allows the master controller to create visual guiding paths 50 having optical characteristics corresponding to the user interface device ID. For instance the guiding paths 50 have different colors. Alternatively, different size light spots or shapes form the guiding paths 50.

In addition to creating a visual guiding path 50, the master controller 25, according to an embodiment of the invention, may transmit information to the object localization user interface device 40 on the location of the object 10. Determining an absolute or relative position with respect to a reference coordinate system then forms an essential prerequisite. The master controller 25 may determine such an absolute or relative position based on information on the location of the light sources 30 stored in a memory, such as for instance a look-up table, and the measured illumination level at the location of the object. For instance, describing the light sources 30 as point sources, standard light theory teaches the illumination level to decrease according to a reciprocal square law of the distance between the light source and the measurement point. For non-point sources the same theory provides other distance dependencies of the illumination level. As the master controller 25 controls the intensity of the light emitted by the light sources 30, it may pinpoint the position of the object using the individual contributions to the illumination and standard triangulation.

According to an aspect, the invention provides a light sensitive tag 11. This tag is arranged (i) to measure the illumination provided by a plurality of light sources 30 of a lighting infrastructure 27, (ii) to identify the light sources 30 illuminating the tag 11 by light source identification codes 35 comprised in the light emitted, and (ii) to transmit data relating to the measured illumination and the light source identification codes 35 to a master controller 25 of the lighting infrastructure 27. Furthermore the tag is arranged, in responds to a user defined request, to instruct the master controller 25 to control the plurality of light sources 30 of the lighting infrastructure 27 to provide a visible feedback signal on or in the vicinity of the tag 11 in dependence on the tag's location relative to the lighting infrastructure 27.

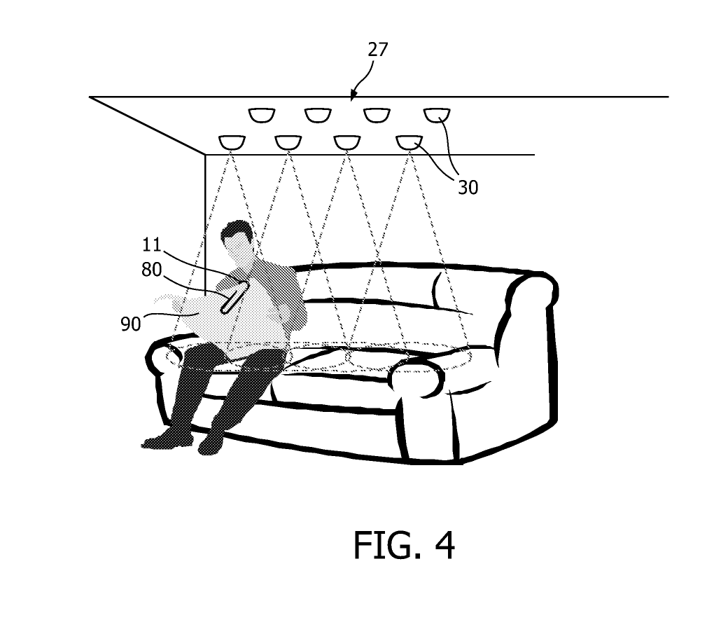

In an embodiment (FIG. 4), a clip-able appliance 80, such as a paperclip or a pen, comprises the tag 11. In an embodiment the tag instructs the lighting infrastructure 27 in dependence on the location or ‘state’ of the paperclip 80. For instance, the instruction results in a spot light being focused on or in the vicinity of the tag 11. The ‘state’ of the paperclip 80 indicates the contextual situation in which it is uses. An example of such a contextual situation is whether or not the paperclip 80 is clipped on an object. Another example is whether a book 90 on which the paperclip is clipped is open or closed. Furthermore, position, movement, and/or orientation of the paperclip 80 may provide whether the book is being read or not. In a non-reading situation of the book 90, the tag 11 may instruct the lighting infrastructure 27 to provide a basic general illumination level with an average light intensity (typically somewhere between 100 and 500 lux). When, however, the book 90 is opened to be read and the paperclip is clipped on the book, a reading spotlight will be focused on the book, providing the (elderly) reader with an illumination level appropriate for the activity.

In an embodiment the paperclip 80, the width of its opening controls a lighting parameter of the light emitted by the light sources 30 of the lighting infrastructure 27, such as for instance the light intensity, the spot size, or the color. As an example, if the paperclip 80 clips only a few pages, the tag instructs the infrastructure to provide a normal spot. If, however, it clips many pages a brighter spot light is provided.

In an embodiment, a pen 80 comprises the tag 11. Clicking the pen may induce the tag to instruct the lighting infrastructure 27 to provide an appropriate lighting pattern. When using the pen to write (as detected by movement sensors) a spot light may be provided at the writing location. Turning of the pen may alter the light intensity or color. Alternatively, toggling the pen on/off may provide the user interaction to control the lighting setting.

In an embodiment, the tag 11 may be provided with memory in order to (re-)program it with a set of desired light effects. Advantageously, programming makes use of a wireless connection (USB, Bluetooth, RF, etc), although in principle classical dipswitches may be used.

Another application uses the light sensitive tag 11 comprised in a clip-able appliance 80 on a saleable item in a shop, e.g. a bag presented on a shelf in a fashion shop. Clipping the tag on the item automatically controls the lighting setting of the lighting infrastructure 27. For example, application of the tag 11 guarantees the correct light setting. Advantageously, such an application facilitates shop assistants as they will not need to worry about the illumination if customers dislocate the item after inspection.

Although the invention has been elucidated with reference to the embodiments described above, it will be evident that alternative embodiments may be used to achieve the same objective. The scope of the invention is therefore not limited to the embodiments described above, but can also be applied to any other object localization application, such as, for example, a security application wherein an object transported beyond the limits of a predetermined area triggers an alarm system. Moreover, and merely as an example, the invention can be applied in a car localization system, installed in an airport car park, guiding the returning flyer to his vehicle.

1. A method for locating an object comprising a light sensitive tag within an environment having a lighting infrastructure associated therewith, the method comprising the steps of:
identifying the object,
providing an illumination device from the lighting infrastructure, the illumination device comprising a plurality of light sources modulated to emit light comprising light source identification codes,
illuminating the tag with the light,
causing the tag to measure the illumination and to identify the light sources illuminating the tag by their light source identification codes,
transmitting object location data from the tag relating to the measured illumination and light source identification codes to a master controller arranged to control the illumination device,
providing a feedback signal related to the object using the master controller.

2. The method according to claim 1, wherein the step of providing the feedback signal comprises controlling the light emitted by the lighting infrastructure based at least in part on the transmitted object location data to create a visual feedback signal related to the location of the object and comprising a dynamic or a static lighting effect.

3. (canceled)

4. The method according to claim 3, wherein the dynamic or the static light effect comprises an intensity or color change.

5. The method according to claim 2, further comprising the steps of arranging the lighting infrastructure in at least a first group and a second group of light sources and creating the visual feedback signal by controlling the light emitted by the first group.

6. The method according to claim 5, further comprising the step of controlling the light emitted by the second group to enhance the contrast between the visual feedback signal and lighting conditions in the environment.

7. The method according to claim 1, further comprising the step of providing an object localization user interface device for identifying the object and requesting the tag to measure the illumination and to identify the light sources by their light source identification codes.

8. The method according to claim 7, further comprising the step of locating the object localization user interface device relative to the light sources on the basis of measured illumination and light source identification codes, transmitting device location data from the object localization user interface device relating to the measured illumination and light source identification codes to the master controller, and controlling the intensity of the light emitted by the lighting infrastructure to create a visual guiding path from the location of the object localization user interface device to the location of the object.

9. A system for locating an object within an environment having a lighting infrastructure associated therewith, the system comprising:
an illumination device from the lighting infrastructure, the illumination device comprising a plurality of light sources arranged to emit light modulated to comprise light source identification codes,
a light sensitive tag associated with the object and arranged to measure the illumination and to identify the light sources illuminating the tag by their light source identification codes,
a master controller arranged to receive location data from the tag relating to the measured illumination and light source identification codes and to provide a feedback signal related to the location of the object.

10. The system according to claim 9, wherein the lighting infrastructure is arranged to create a visual feedback signal on or around the object by controlling the light emitted by the light sources based at least in part on the received location data.

11. (canceled)

12. The system according to claim 9, further comprising an object localization user interface device for identifying the object.

13-16. (canceled)
